(19) United States
(12) Patent Application Publication
(10) Pub. No.: US 2025/0344112 A1
(43) Pub. Date: Nov. 6, 2025

(54) PRIORITY FOR HANDOVER CANDIDATE CELL MEASUREMENT

(71) Applicant: QUALCOMM Incorporated, San Diego, CA (US)

(72) Inventors: Yan ZHOU, San Diego, CA (US); Yongle WU, San Diego, CA (US); Kiran VENUGOPAL, Green Brook, NJ (US); Jing JIANG, San Diego, CA (US); Yong LI, San Diego, CA (US)

(21) Appl. No.: 18/654,793

(22) Filed: May 3, 2024

(51) Int. Cl. H04W 36/00; H04W 36/08

(52) U.S. Cl. CPC H04W 36/0058; H04W 36/08

(57) ABSTRACT

Certain aspects of the present disclosure provide techniques for handover candidate cell measurement priority. An example method, performed at a user equipment (UE), generally includes obtaining assistance information for prioritized cell measurement reporting for a set of candidate cells, wherein the UE supports triggered mobility to switch between the candidate cells, measuring reference signals (RSs), wherein each of the RSs is associated with one of the candidate cells, generating, based on the measuring, a report that indicates at least one measured metric for different candidate cells that are selected in accordance the assistance information, and transmitting the report.

### FIELD OF THE DISCLOSURE

Aspects of the present disclosure relate to wireless communications, and more particularly, to techniques for handover candidate cell measurement priority.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications at a user equipment (UE). The method includes obtaining assistance information for prioritizing which candidate cells, from a configured set of candidate cells, are included in a cell measurement report, wherein the UE supports triggered mobility to switch between the candidate cells; measuring reference signals (RSs), wherein each of the RSs is associated with one of the candidate cells; and transmitting, based on the measuring, the cell measurement report that indicates at least one measured metric for different candidate cells that are selected in accordance with the assistance information.

Another aspect provides a method for wireless communications at a network entity. The method includes transmitting assistance information for prioritizing which candidate cells, from a configured set of candidate cells, are included in a cell measurement report; and receiving, based on measurement of reference signals (RSs) associated with the candidate cells, the cell measurement report that indicates at least one measured metric for different candidate cells that are selected in accordance the assistance information.

Other aspects provide: an apparatus operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example scenario with a pre-configured candidate cell set.

FIG. 6 depicts an example of UE mobility.

FIG. 7 depicts an example cell switch command random access channel (RACH) procedure.

FIG. 8 depicts an example cell reselection scenario.

FIG. 9 depicts an example lower-layer triggered mobility (LTM) report.

FIG. 10 depicts a call flow diagram, in accordance with certain aspects of the present disclosure.

FIG. 11 depicts a diagram illustrating example assistance information, in accordance with certain aspects of the present disclosure.

FIG. 12 depicts a method for wireless communications.

FIG. 13 depicts a method for wireless communications.

FIG. 14 depicts aspects of an example communications device.

### DETAILED DESCRIPTION

Aspects of the present disclosure provide apparatuses, methods, processing systems, and computer-readable mediums for handover candidate cell measurement priority.

In advanced wireless systems, mobility procedures are in place to help maintain network connections for a wireless device, such as a user equipment (UE), as it moves between the coverage areas of different cells. Mobility procedures generally refer to mechanisms that allow a UE to transition from being served by a source cell to being served by a target/candidate cell. Such a transition is generally be referred to as a handover.

In some cases, for physical layer (PHY or Layer 1/L1) and/or medium access control layer (MAC or Layer 2/L2), also referred to as L1/L2 triggered mobility (LTM), as a UE moves, a new serving cell (e.g. a primary cell (Pcell)) may be selected (e.g., reselected) for handover among a set of pre-configured candidate cells. The new serving cell may be selected based on measurements of reference signal (RS) made at the physical (PHY or L1) layer (referred to as L1 measurements) for the candidate cells. The RSs are typically sent with different beams. To facilitate a handover decision, the UE may generate beam reports containing information about the received signal quality from the different beams of the serving cell and/or candidate cells. These beam reports may then be sent to a serving cell. For example, such beam reports may include measurements (e.g., reference signal (RS) receive power (RSRP), signal to interference and noise ratio (SINR)) for M beams for each of L (serving and/or candidate) cells. Thus, the reports may include M×L total measurements.

In some cases, such reporting may be less than optimal due to insufficient knowledge regarding candidate cells. For example, without sufficient knowledge, the UE may choose to prioritize reporting cells with a high L1-RSRP in the report even though those cells may be less than ideal candidates for a handover. For example, such cells (having high L1-RSRP) may be at a lower frequency band, with a smaller bandwidth resulting in lower throughput (e.g., <1-2 GHz), or may have higher cell load resulting in lower throughput. In addition, measuring all candidate cells would result in significant increases in reporting latency and UE power consumption.

Aspects of the present disclosure, however, provide techniques for handover candidate cell measurement priority. According to certain aspects, for example, a network entity (e.g., source cell(s)) may provide the UE with assistance information indicating measurement priority per candidate cell and/or per measured frequency. Utilization of the techniques disclosed herein may improve handover efficiency and performance via improved prioritization of handover candidate cell measurement and/or reporting.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

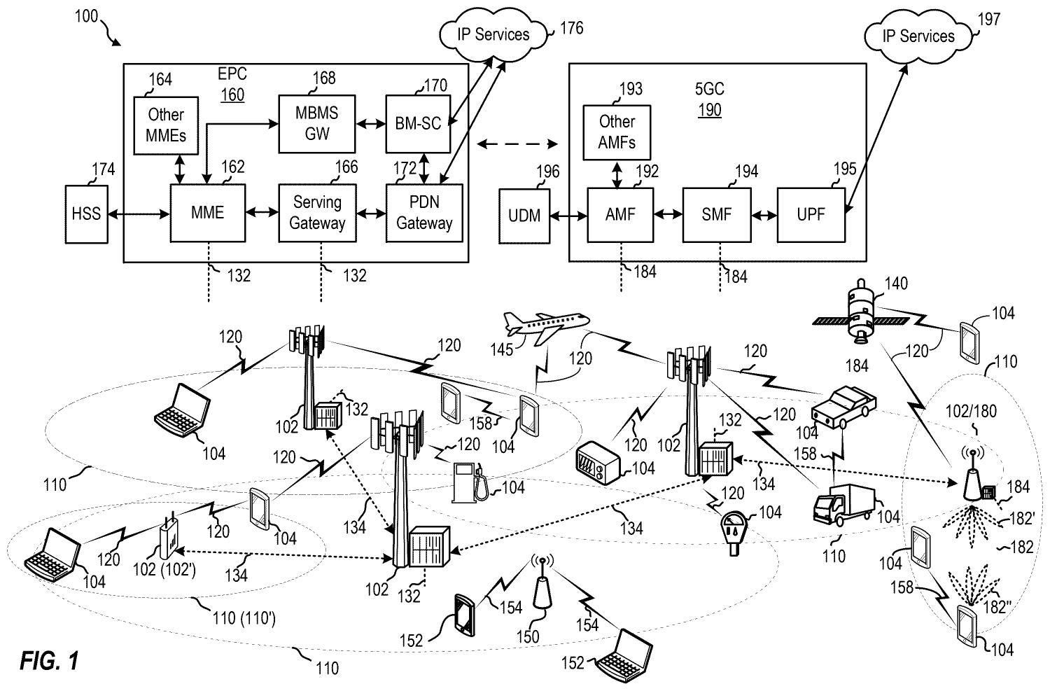

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

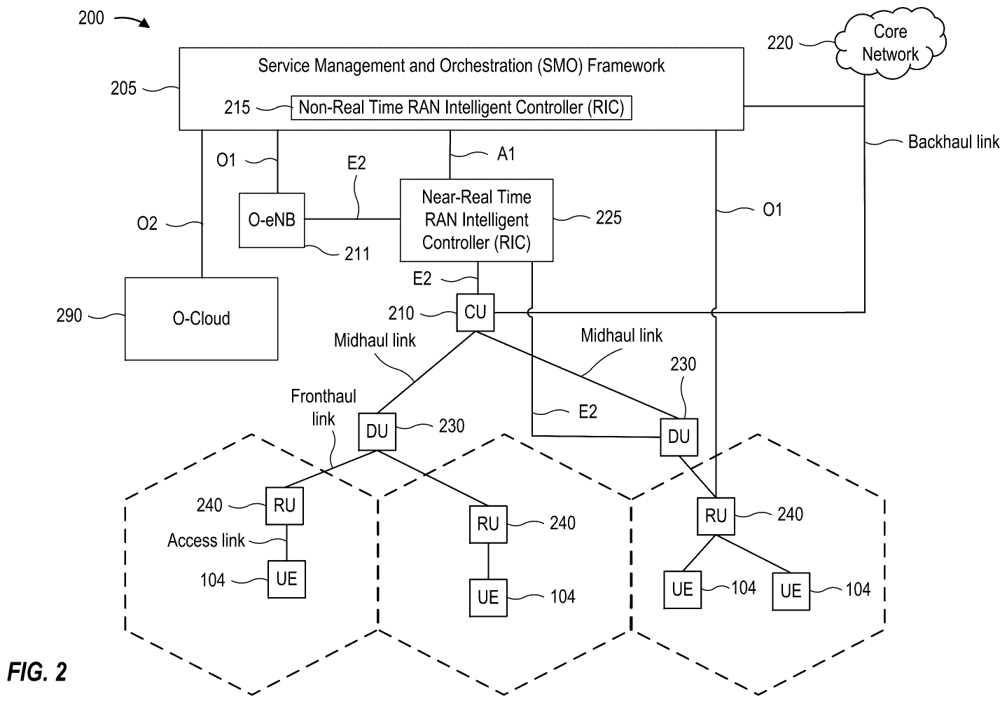

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an AI interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as AI policies).

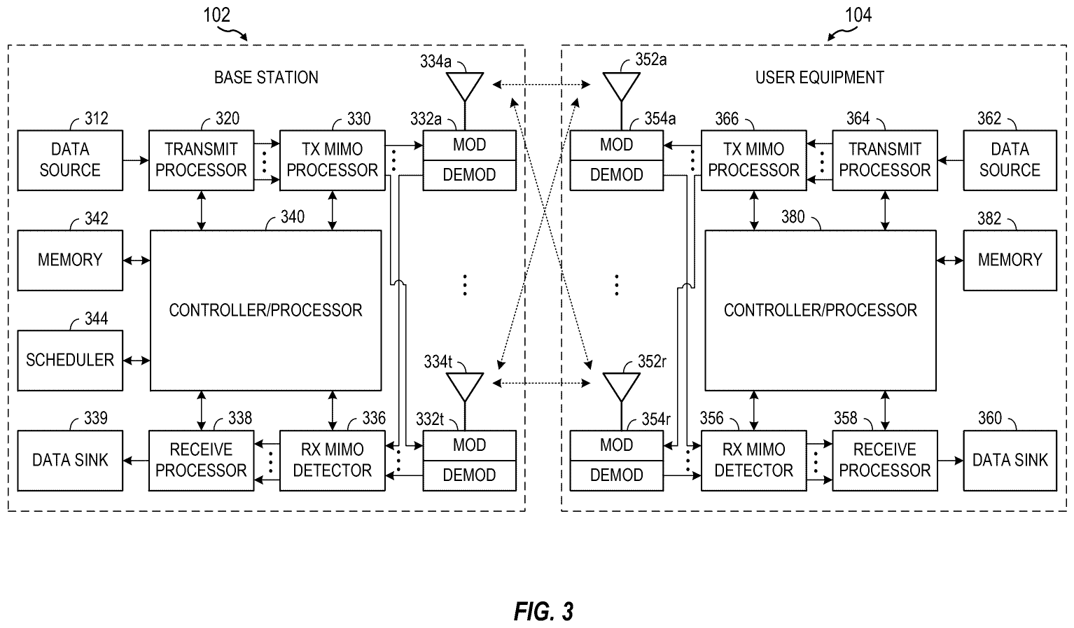

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

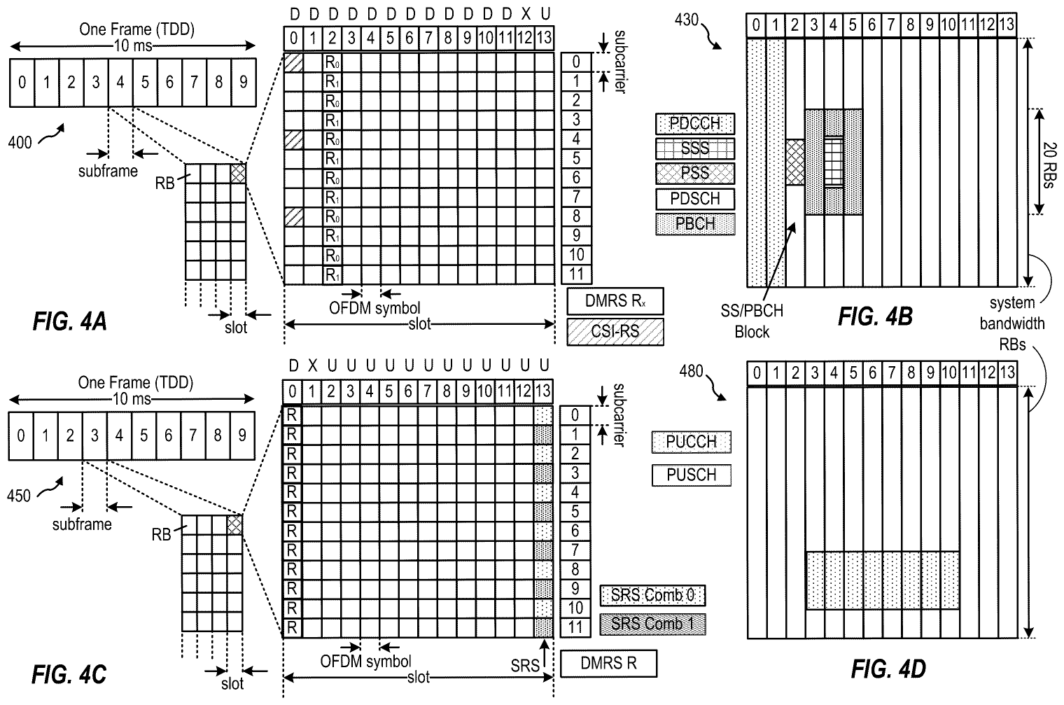

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2×15 kHz, where is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 s.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Overview of PRACH Triggering and Cell Mobility

PRACH triggering from a network entity may be based on higher layer signaling (e.g., RRC) or, in some cases, lower layer signaling such as a physical downlink control channel (PDCCH). In some cases, PRACH transmissions for uplink (UL) timing in a candidate cell may be triggered via a downlink control information (DCI) from a serving cell.

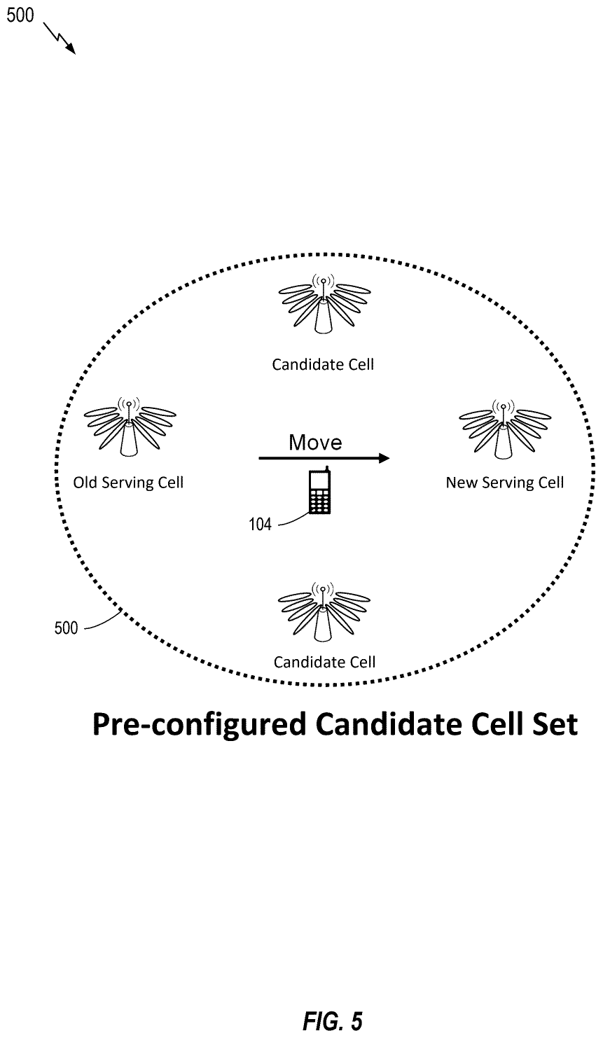

Triggering PRACH transmissions may be beneficial in the scenario illustrated in FIG. 5, where a UE may move between a preconfigured set 500 of candidate cells. In the illustrated example, the UE moves from a first cell (e.g., an old serving/primary cell) to a new serving candidate cell. In this case, the UE may not receive data or control information in the candidate cell, but may transmit a PRACH in order to facilitate timing adjustment for the new candidate cell before a cell change.

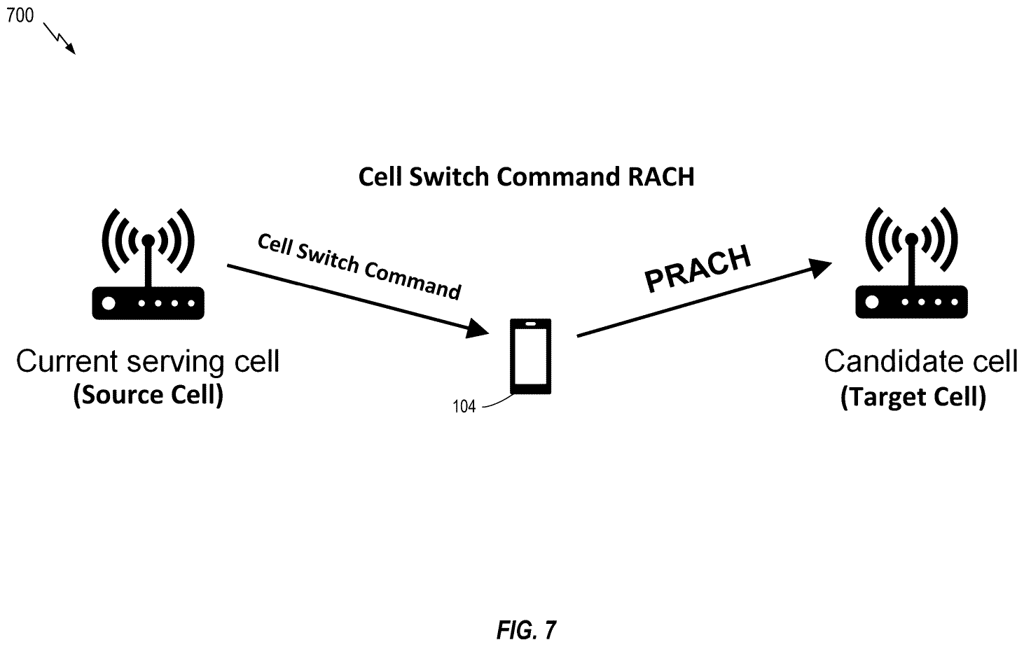

As will be described in greater detail below, with reference to FIG. 7, a RACH may be triggered via a cell switch command (e.g., a MAC-CE). The cell switch command may be sent by a source/serving cell in order to trigger a RACH transmission in a candidate/target cell.

### Overview of Dynamic Signaling-Based Mobility

As noted above, dynamic mobility signaling (e.g., L1 and/or L2-centric mobility or LTM) may lead to more efficient intra-cell and inter-cell mobility with reduced latency.

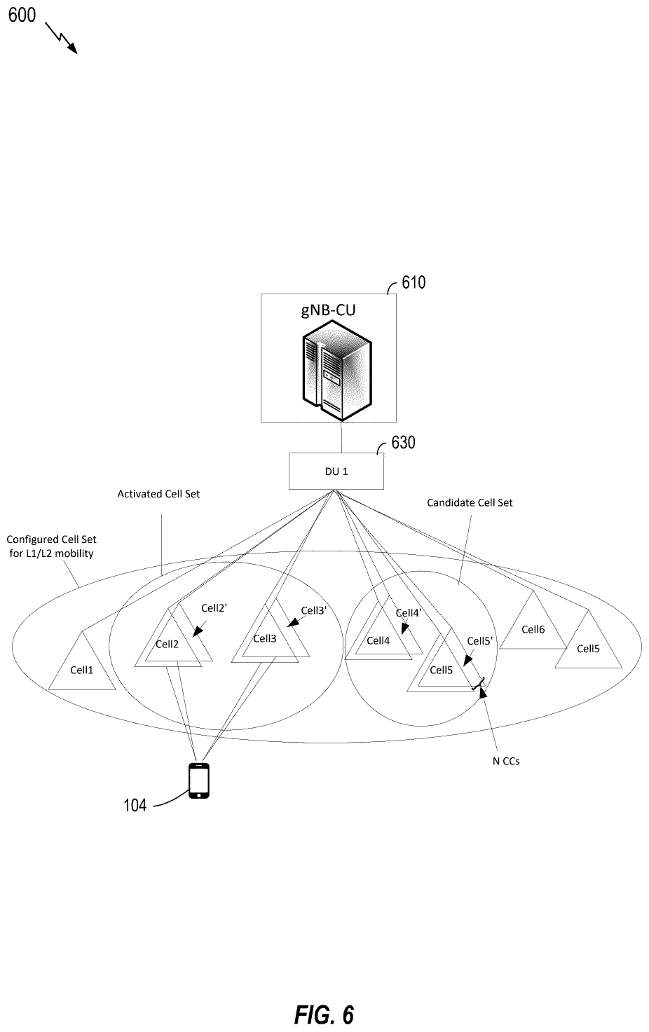

The general concept of LTM signaling may be understood with reference to the example scenario 600 shown in FIG. 6. As illustrated, the network may configure (e.g., via RRC signaling), a set of cells for L1/L2 mobility (referred to herein as an L1/L2 Mobility Configured cell set). At any given time, the network may also configure (via L1/L2 signaling) an L1/L2 Mobility Activated cell set, which refers to a group of cells in the configured set that are activated and can be readily used for data and control transfer. The network may also configure (signal) an L1/L2 Mobility Deactivated cell set, which refers to a group of cells in the configured set that are deactivated and can be readily activated by L1/L2 signaling.

L1/L2 signaling may be used for mobility management of the activated set. For example, L1/L2 signaling may be used to activate/deactivate cells in the set, select beams within the activated cells, and update/switch a primary cell (PCell). This dynamic signaling may help provide seamless mobility within the activated cells in the set. In other words, as the UE moves, the cells from the set are deactivated and activated by L1/L2 signaling. The cells to activate and deactivate may be based on various factors, such as signal quality (measurements) and loading.

As in the example illustrated in FIG. 6, in some cases, all cells in the L1/L2 Mobility Configured cell set may belong to the same DU 630 of a CU 610. This may be similar to carrier aggregation (CA), but cells may be on the same carrier frequencies. The size of the cell set configured for L1/L2 mobility signaling may vary. In general, the cell set size may be selected to be large enough to cover a meaningful mobility area.

In some cases, the UE may be provided with a subset of deactivated cells, as a candidate cell set, from which the UE could autonomously choose to add to the activated cell set. The decision of whether to add a cell from the candidate cell set to the activated cell set may be a based various factors, such as measured channel quality and loading information. In some cases, the ability for the UE to autonomously choose to add to the activated cell set may be similar to a UE decision when configured for Conditional Handover (CHO) for fast and efficient addition of the prepared cells.

As illustrated in FIG. 6, each cell may be served by an RU. Each of the RUs may have multi-carrier (N CCs) support. In such cases, each CC may be a cell (e.g., Cell 2 and Cell 2′ may be different CCs of the same RU). In such cases, activation/deactivation can be done in groups of carriers (cells).

For PCell management, L1/L2 signaling may be used to set (select) the PCell out of the preconfigured options within the activated cell set. In some cases, L3 mobility may be used for PCell change (L3 handover) when a new PCell is not from the activated cell set for L1/L2 mobility. In such cases, RRC signaling may update the set of cells for L1/L2 mobility at L3 handover.

In some cases, physical layer (Layer 1 or L1) measurement may be enhanced for L1/L2 mobility, where a serving cell can be changed via L1/L2 signalling based on L1 measurement, and both synchronous and asynchronous source and target cells may be considered.

Various mechanisms and procedures of L1/L2 based inter-cell mobility may be specified for mobility latency reduction. These may include configuration and maintenance for multiple candidate cells to allow fast application of configurations for candidate cells. Dynamic switching mechanisms among candidate serving cells (including SpCell and SCell) may be supported for the potential applicable scenarios based on L1/L2 signaling.

L1 enhancements for inter-cell beam management, may include L1 measurement and reporting, as well as beam indication. Timing Advance (TA) management and CU-DU interface signaling may also be provided to support L1/L2 mobility.

L1/L2 based inter-cell mobility procedures may be applicable to a variety of scenarios. These scenarios may include standalone, CA and new radio-dual connectivity (NR-DC) cases with serving cell change within one cell group (CG), intra-distributed unit (DU) cases and intra-central unit (CU) inter-DU cases, intra-frequency and inter-frequency scenarios, both FR1 and FR2 scenarios, and scenarios where source and target cells may be synchronized or non-synchronized.

As noted above, a cell switch command may be sent by a source/serving cell in order to trigger a RACH transmission in a candidate/target cell. FIG. 7 depicts an example 700 of such a cell switch command triggered RACH transmission.

As noted above, for layer 1/2 (L1/L2) triggered mobility (LTM), as a UE moves, a new serving cell may be selected (e.g., reselected) among a set of pre-configured candidate cells based on the UE's L1 measurement for those cells. To save timing advance (TA) acquisition time, a UE may send a physical random access channel (PRACH) to a target candidate cell for TA measurement before it is selected as a new serving cell. While LTM generally refers to UE mobility (moving from a source cell to a target candidate cell) triggered via L1 and/or L2 signaling, a broader term triggered mobility may also include L3 signaling (in addition to L1 and/or L2 signaling).

PRACH triggering from the network entity may be based on a cell switch command, as illustrated in FIG. 7. For example, as shown, a current serving cell may transmit a cell switch command to a UE. As illustrated, the cell switch command may trigger the UE to transmit a PRACH to a candidate cell before it is selected as a new serving cell (e.g., in order to save TA acquisition time).

As illustrated, the UE may participate in the PRACH procedure (e.g., transmit the PRACH) using a beam selected in accordance with the command (e.g., based on information present or absent in the command).

### Aspects Related to Handover Candidate Cell Measurement Priority

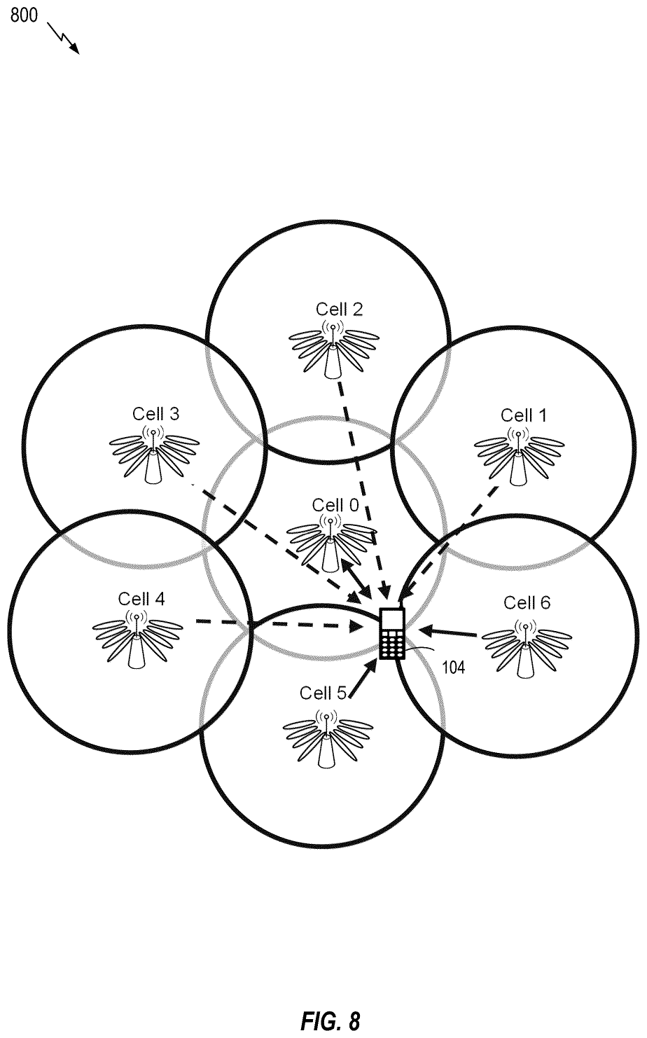

FIG. 8 depicts an example cell reselection scenario 800 that assumes a UE 104 has been configured with a set of candidate cells (e.g., Cells 0-6).

In the illustrated example, the UE may measure RS(s) from one or more of Cells 0-6. Based on results of the measurements, UE 104 may move from a first cell (e.g., an old serving/primary cell) to a new serving candidate cell. In this case, the UE may not receive data or control information in the candidate cell, but may transmit a PRACH in order to facilitate timing adjustment for the new candidate cell before a cell change.

In 5G, a neighbor cell list for idle UE cell reselection may be broadcast in a system information block (SIB), and may be common for all SSBs. In some cases, an intra-frequency neighbor cell list may be broadcast in SIB 3, an inter-frequency neighbor cell list may be broadcast in SIB 4, and an inter-RAT neighbor cell list may be broadcast in SIB 5. In some cases, a common configuration for intra-frequency, inter-frequency, and inter-RAT cell reselection may be broadcast in SIB 2.

In addition, a network entity (e.g., a gNB) may provide reselection priority per frequency in case of inter-frequency and inter-RAT idle UE cell reselection. In some cases, the reselection priority may be provided in terms of configured priority and sub-priority levels (e.g., 8 priority levels+4 sub-priority levels).

As noted above, for LTM, a UE may measure and report results of RS measurements, each corresponding to a cell and beam.

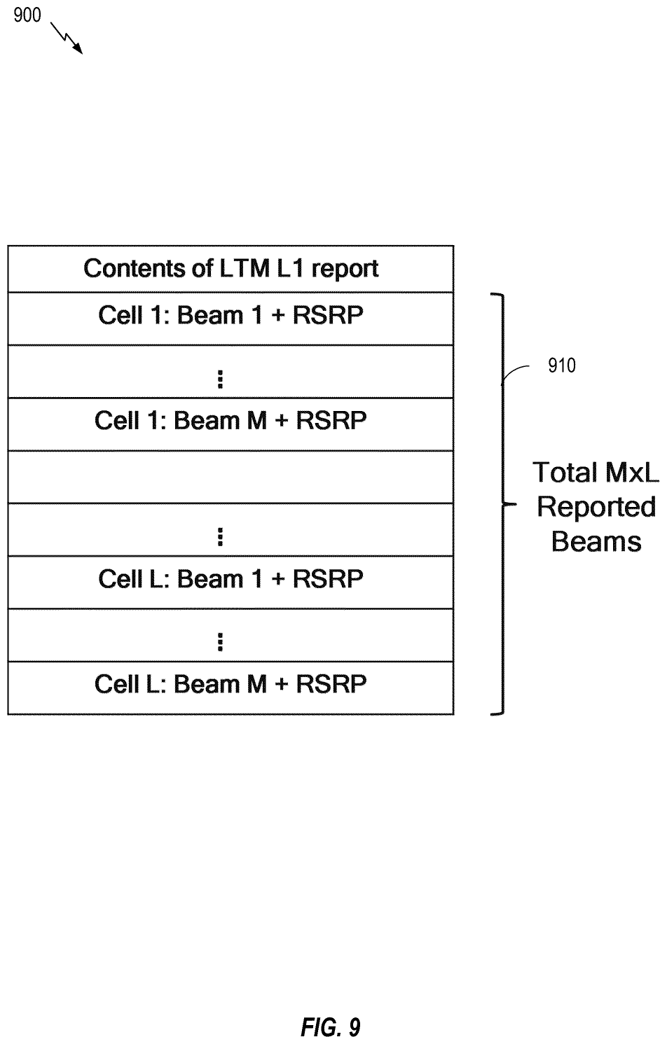

FIG. 9 depicts an example format 900 of such an LTM measurement report (e.g., including absolute values of measurements). The LTM report may indicate, for example, an absolute RSRP value associated with each beam. As illustrated at 910, a single LTM report may include measurements for M beams for each of L configured (e.g., or activated, if introduced) cells. In some cases, the selection of the M beams may be determined at a UE.

In some cases, maximum values of M and L (e.g., the total number of beams that may be reported in a single LTM report) may be based on UE capability. For example, in some cases, M*L=4 beams may be supported as a UE capability. In some cases, the values of M and L may be configured to the UE in a reporting configuration.

As noted above, such LTM reporting may be less than optimal due to insufficient knowledge regarding candidate cells. For example, without sufficient knowledge, the UE may choose to prioritize reporting cells with a high L1-RSRP in the report even though those cells may be less than ideal candidates for a handover. For example, such cells (having high L1-RSRP) may be at a lower frequency band, with a smaller bandwidth resulting in lower throughput (e.g., <1-2 GHz), or may have higher cell load resulting in lower throughput. In addition, measuring all candidate cells would result in significant increases in reporting latency and UE power consumption.

Aspects of the present disclosure, however, provide techniques for handover candidate cell measurement priority. According to certain aspects, for example, a network entity (e.g., source cell(s)) may provide the UE with assistance information indicating measurement priority per candidate cell and/or per measured frequency. As used herein, prioritized cell measurement reporting generally refers to reporting measurements for certain candidate cells selected based on some criteria other than strongest RS measurements. As will be described in greater detail below, assistance information used to prioritize the selection of cells to include in a measurement report may include information such as cell bandwidth or cell loading that may make a give cell desirable (or undesirable) as a target cell in addition to (or regardless of) RS measurements.

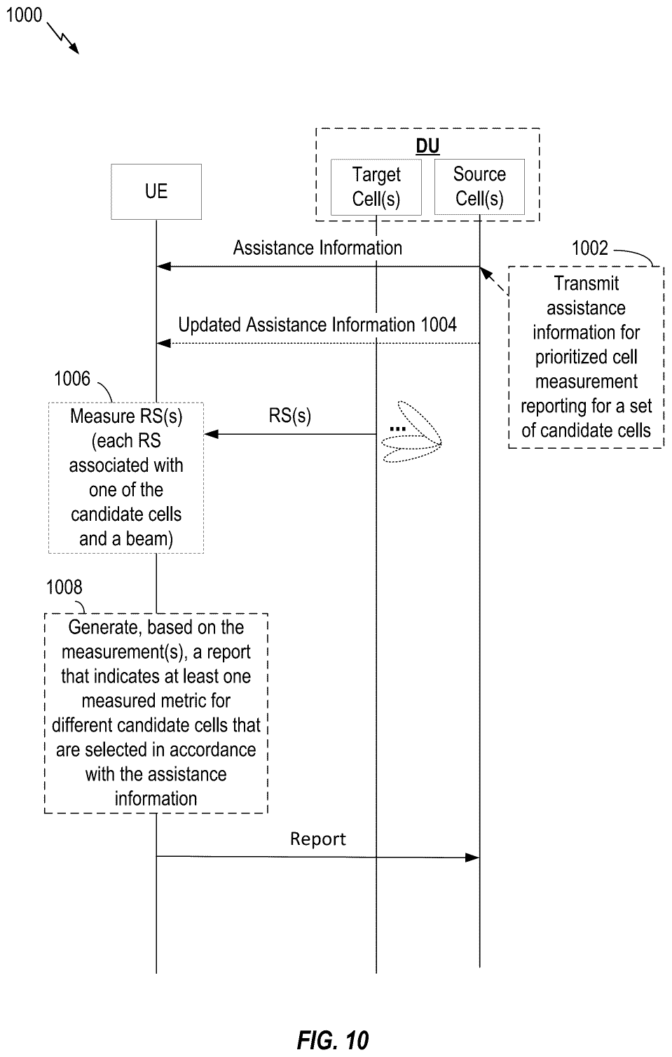

Techniques for prioritizing LTM measurement reporting proposed herein may be understood with reference to the call flow diagram 1000 of FIG. 10. In some aspects, the UE shown in FIG. 10 may be an example of the UE 104 depicted and described with respect to FIGS. 1 and 3. Similarly, the network entities (e.g., target cell(s), source cell(s), and/or DU) shown in FIG. 10 may be examples of the BS 102 (e.g., a gNB) depicted and described with respect to FIGS. 1 and 3 or a disaggregated base station depicted and described with respect to FIG. 2. As illustrated, in some cases, the network entity may include a DU that is associated with a source cell and one or more target cells (e.g., candidate cells for LTM).

As illustrated at 1002, a network entity (e.g., a distributed unit (DU) or a radio unit (RU) associated with source cell(s)) may transmit assistance information for prioritized cell measurement reporting for a set of candidate cells. As illustrated at 1004, the network entity may transmit updated assistance information.

As illustrated at 1006, the UE may measure RS(s), where each RS is associated with one of the candidate cells and a beam.

As illustrated at 1008, the UE may generate, based on the measurement(s) of RS(s), a report that indicates at least one measured metric for different candidate cells that are selected in accordance with the assistance information. As illustrated, the UE may transmit the report to the source cell(s) (e.g., RU(s) associated with source cell(s)).

By considering the assistance information, the UE may make a more optimal selection of which cells to include in the measurement report. The assistance information may, thus, be used to prioritize cells for LTM measurement reporting (e.g., considering factors such as cell bandwidth, cell loading, and the like).

In some aspects, for LTM or L3 triggered mobility, a network entity (e.g., a gNB) may provide measurement priority on a per candidate cell and/or a per measured frequency basis. For each priority, certain cell/beam quality threshold(s) can be indicated as well (e.g., a minimum L1-RSRP/SINR that each or an average of the top X beams of a cell should satisfy, where the value of X may be indicated by the network).

In such cases, a UE may first measure cells or frequencies with the highest priority. If a total number of cells with cell/beam quality above the threshold is less than the total cell number to be reported, the UE may then continue to measure cells or frequencies with lower priority.

If all candidate cells have been measured, but the total number of cells with quality above the threshold for the corresponding priority is still less than the total cell number to be reported, the remaining cells to be reported may be selected based on UE implementation.

In some aspects, the frequency, RAT, and/or cell measurement/report priority may be implicitly determined based on an identifier (ID) of a corresponding RRC message, or an order index of the corresponding RRC message in the associated list.

For example, in the case of L3 measurement based mobility, an RRC message may include a measurement object, a report configuration, and/or individual cell information. In the case of L1 measurement based mobility, an RRC message may include an LTM CSI resource configuration, an LTM CSI report configuration, and/or LTM candidate cell information. In some aspects, a separate RRC flag may be used to indicate that the above implicit determination rule is applied. In other words, if this flag is set in an RRC message, a UE may know to implicitly determine how to prioritize cells for LTM measurement reporting (e.g., rather than conventional reporting based on highest RSRP measurements).

In the example of L3 measurement based mobility, measurement priority of frequencies, RATs, and/or cells may be determined by the associated measurement ID or measurement object ID. For example, a smaller ID value and/or a smaller order index in the measurement ID list or measurement object ID list may imply higher priority. Among cells associated with the same measurement ID or measurement object ID, measurement priority of each cell can be determined by the order index in the cell list (e.g., smaller order index may imply higher priority).

In the example of L1 measurement based mobility, measurement priority of each cell, associated frequency, and/or RAT can be determined by the corresponding candidate cell or candidate configuration ID. For example, a smaller ID value may imply a higher priority. Alternatively, the cell measurement priority may be determined by the order index in the candidate cell list. For example, a smaller order index may imply a higher priority.

In some aspects, instead of providing measurement priority information, the network may provide (as assistance information) scaling factor(s) or offset(s) to the measured metric per candidate cell or per measured frequency. For example, the measured L1 or L3 RSRP, SINR, and/or RSRQ values can be multiplied with a scaling factor (e.g., from 0 to 1), or added with an offset with a value determined as a function of the parameters of the cell. In such cases, a higher (scaling or offset) value may be provided for larger cells, bandwidth parts (BWPs) or bandwidths, and a lower value may be provided for cells or frequencies with higher loads. In some aspects, the same scaling factor or offset may be indicated per candidate cell, or for all candidate cells on a particular frequency. The UE may then report the top X cells/beams in a report by ranking cells/beams based on corresponding adjusted (based on the scaling value or offset) metrics.

In some aspects, in an effort to better support successive LTM handovers (e.g., to avoid RRC reconfiguration during multiple cell switches), the network may dynamically update assistance information for prioritized cell measurement/report (e.g., via DCI and/or MAC-CE). The updated assistance information may include, for example, priority or scaling factor/offset per measured cell/frequency, cell load information (e.g., X % of resources are used, and can be DL only, UL only, or joint DL/UL resources), cell configuration information (e.g., cell bandwidth, individual DL/UL BWP bandwidth. In addition, or as an alternative, the updated assistance information may also include TDD slot/symbol pattern, max DL/UL layers), available resources per cell for a new UE (e.g., X % of available time and/or BW, available RB numbers, available slots per frame), and/or expected quality of service (QoS) per cell for a new UE (e.g., expected DL/UL throughput, latency, BLER, which can be based on a certain reference packet size and/or link quality (RSRP/SINR)).

Some of the per-cell metrics described above may also be indicated as per-frequency metrics by indicating statistics of per-cell metrics for all the measured candidate cells on that frequency (e.g., average, min/max, or X percentile).

As noted above, the network (e.g., a gNB) may dynamically update the assistance information for prioritized cell measurement/reporting via DCI, MAC-CE, SIB, and/or MIB. In some aspects, a new DCI/MAC-CE format may be used (dedicated) for assistance information updates. Alternatively, existing DCI/MAC-CE formats may be modified (e.g., using reserved bits, repurposing existing fields, and/or adding new fields) to allow for dynamic updates for the assistance information. In some aspects, the DCI/MAC-CE can be unicast. In some aspects, the DCI/MAC-CE can be group cast or broadcast (e.g., to save overhead).

In some aspects, the assistance information may be added to DCI used to (de)activate semi-persistent (SP) CSI reporting on PUSCH. For example, the existing DCI format 0_1 or 0_2 scrambled by SP-CSI-RNTI may be added with up to 8 new bits to sequentially indicate a binary high/low measurement priority value per measured candidate cell or frequency based on the order in the resource set linked to the (de)activated SP report configuration.

As another example, the measurement priority assistance information can be added to a MAC-CE used to (de)activate SP CSI reporting on PUCCH. For example, for the (de)activated SP report configuration corresponding to the field Sₓ, measurement priority assistance information can be sequentially provided per measured candidate cell or frequency based on the order in the resource set linked to that SP report configuration.

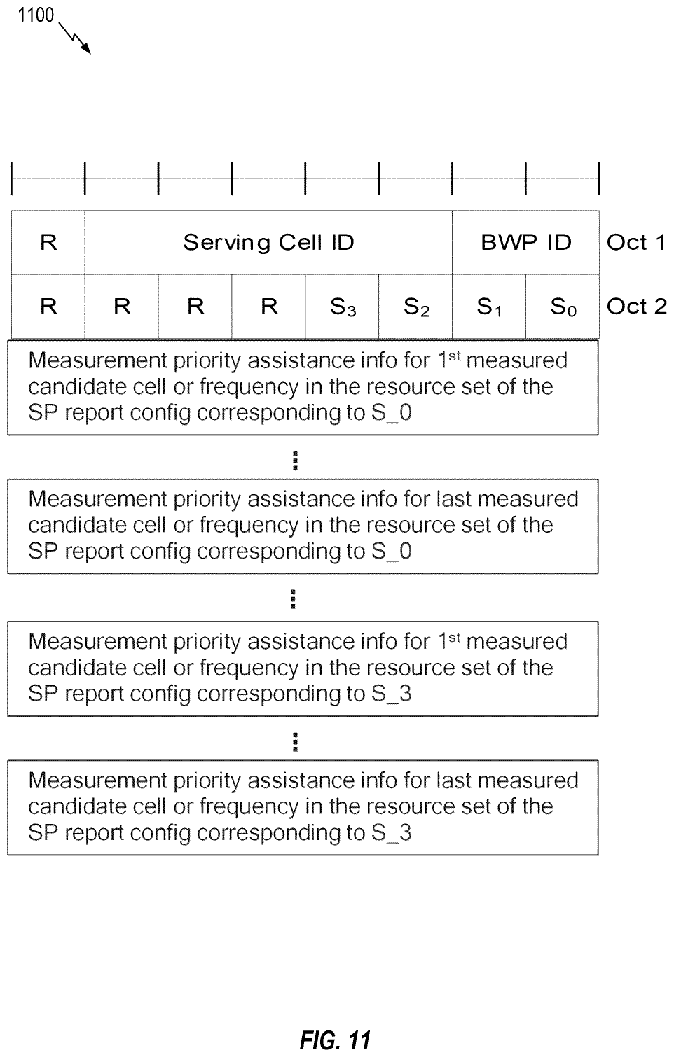

This type of assistance information indication may be understood with reference to FIG. 11, which depicts a diagram 1100 illustrating example assistance information provided in a MAC-CE, in accordance with certain aspects of the present disclosure. As illustrated, measurement priority assistance information may be provided sequentially (e.g., per cell or frequency) in a MAC-CE for each (de)activated SP report configuration corresponding to each of fields S₀, S₁, S₂, and S₃.

According to certain aspects of the present disclosure, handover candidate cell measurement priority may be based on UE implementation. For example, a UE may prioritize measured/reported cells based on its own memorized cell information. In some aspects, for example, a UE may prioritize reported cells with larger bandwidths, MIMO layers, typically light loads, and/or good throughput/latency experience, even when their RSRP are not the best (e.g., among a configured set of candidate cells). In such cases, the UE may store, in memory, certain configurations (e.g., relating to bandwidth, MIMO layers, etc.) on a per cell basis.

As noted above, utilization of the techniques disclosed herein may improve handover efficiency and performance via improved prioritization of handover candidate cell measurement and/or reporting. For example, in certain scenarios using prioritized LTM measurement reporting, significant throughput gains may be achieved, with relatively small SNR loss depending on UE location relative to candidate target cells.

### Example Operations

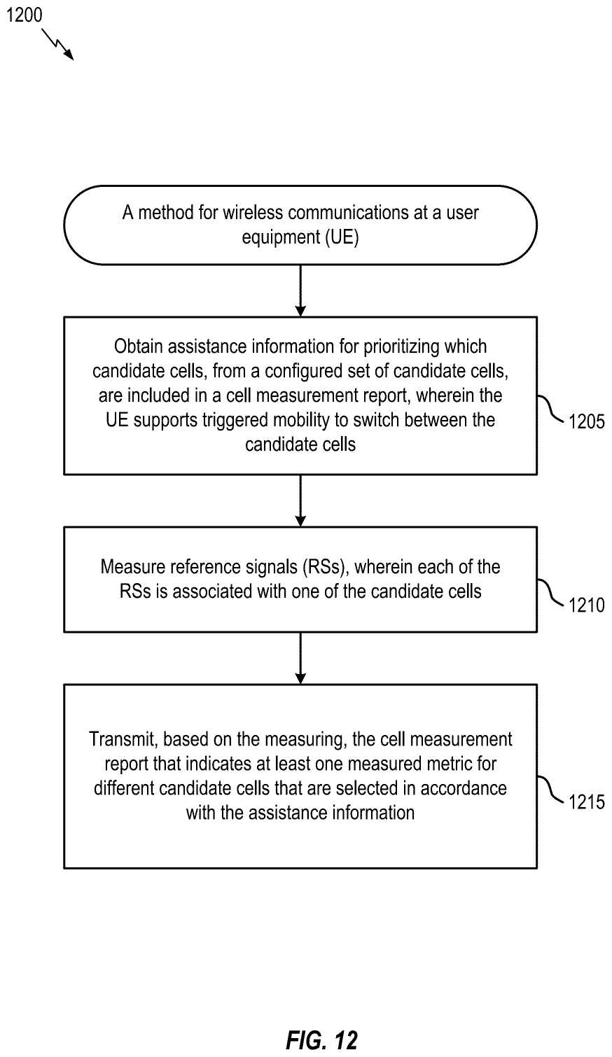

FIG. 12 shows an example of a method 1200 of wireless communications at a user equipment (UE), such as a UE 104 of FIGS. 1 and 3.

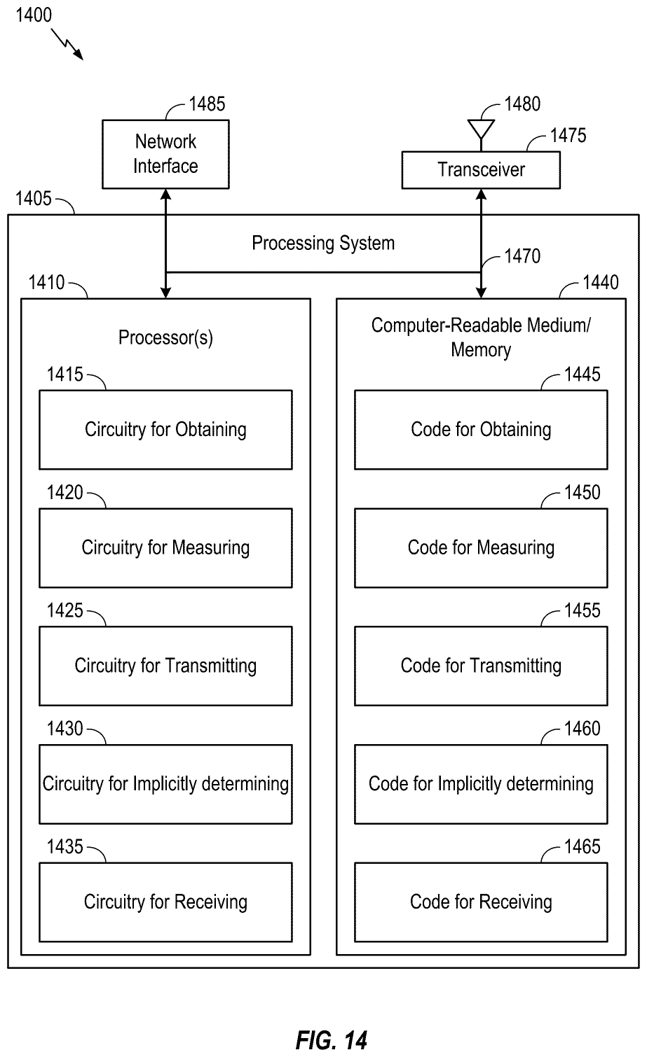

Method 1200 begins at step 1205 with obtaining assistance information for prioritizing which candidate cells, from a configured set of candidate cells, are included in a cell measurement report, wherein the UE supports triggered mobility to switch between the candidate cells. In some cases, the operations of this step refer to, or may be performed by, circuitry for obtaining and/or code for obtaining as described with reference to FIG. 14.

Method 1200 then proceeds to step 1210 with measuring reference signals (RSs), wherein each of the RSs is associated with one of the candidate cells. In some cases, the operations of this step refer to, or may be performed by, circuitry for measuring and/or code for measuring as described with reference to FIG. 14.

Method 1200 then proceeds to step 1215 with transmitting, based on the measuring, the cell measurement report that indicates at least one measured metric for different candidate cells that are selected in accordance with the assistance information. In some cases, the operations of this step refer to, or may be performed by, circuitry for transmitting and/or code for transmitting as described with reference to FIG. 14.

In some aspects, the assistance information comprises priority information that is applicable per candidate cell or per measured frequency.

In some aspects, the assistance information indicates priorities for candidate cells and comprises at least one of: a first quality threshold that measured metrics for candidate cells should meet to be included in the cell measurement report; or a second threshold that measured metrics for candidate cells should meet to be included in the cell measurement report.

In some aspects, the measuring comprises: measuring RS for a first set of candidate cells with higher priorities than a second set of candidate cells; determining that a quantity of candidate cells whose measured metrics exceed the first quality threshold is less than a total quantity of cells to be reported; and measuring metrics for candidate cells in the second set based on the determination.

In some aspects, the method 1200 further includes implicitly determining a priority for a candidate cell based on at least one of: an identifier (ID) or order index of a radio resource control (RRC) message. In some cases, the operations of this step refer to, or may be performed by, circuitry for implicitly determining and/or code for implicitly determining as described with reference to FIG. 14.

In some aspects, the RRC message configures the UE for measuring and reporting measuring results.

In some aspects, if multiple cells are associated with a same ID, the priority for the multiple cells is determined based on the order index.

In some aspects, the assistance information comprises at least one of a scaling factor or an offset to be applied to adjust the measured metrics for the candidate cells; and the cell measurement report is for a subset of the candidate cells selected based on the adjusted measured metrics.

In some aspects, the assistance information comprises scaling factors or offsets that are applicable per candidate cell or per measured frequency.

In some aspects, the assistance information comprises a same scaling factor or offset to be applied to the measured metrics for multiple candidate cells on a particular frequency.

In some aspects, the method 1200 further includes receiving signaling updating at least some of the assistance information, wherein the signaling comprises at least one of downlink control information (DCI), medium access control (MAC) control element (CE), or broadcast signaling. In some cases, the operations of this step refer to, or may be performed by, circuitry for receiving and/or code for receiving as described with reference to FIG. 14.

In some aspects, assistance information updated via the signaling comprises at least one of: at least one of a priority or scaling factor for candidate cells; cell loading for at least one of uplink or downlink; a cell configuration indicating at least one of frequency, time, or spatial resources; available resources per cell for a new UE; expected quality of service (QoS) for a new UE; or resources per cell for a new UE.

In some aspects, the signaling updates assistance information on at least one of a per-cell basis or a per-frequency basis.

In some aspects, the signaling comprises DCI or MAC CE signaling that activates or deactivates semi-persistent CSI reporting.

In one aspect, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative steps are possible consistent with this disclosure.

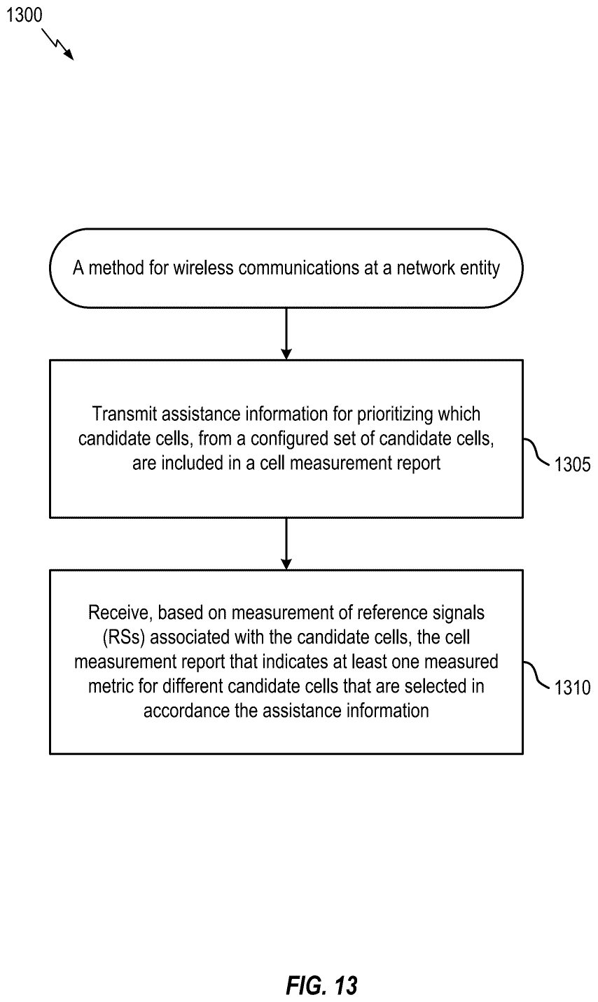

FIG. 13 shows an example of a method 1300 of wireless communications at a network entity, such as a BS 102 of FIGS. 1 and 3, or a disaggregated base station as discussed with respect to FIG. 2.

Method 1300 begins at step 1305 with transmitting assistance information for prioritizing which candidate cells, from a configured set of candidate cells, are included in a cell measurement report. In some cases, the operations of this step refer to, or may be performed by, circuitry for transmitting and/or code for transmitting as described with reference to FIG. 14.

Method 1300 then proceeds to step 1310 with receiving, based on measurement of reference signals (RSs) associated with the candidate cells, the cell measurement report that indicates at least one measured metric for different candidate cells that are selected in accordance the assistance information. In some cases, the operations of this step refer to, or may be performed by, circuitry for receiving and/or code for receiving as described with reference to FIG. 14.

In some aspects, the assistance information comprises priority information that is applicable per candidate cell or per measured frequency.

In some aspects, the assistance information indicates priorities for candidate cells and comprises at least one of: a first quality threshold that measured metrics for candidate cells should meet to be included in the cell measurement report; or a second threshold that measured metrics for candidate cells should meet to be included in the cell measurement report.

In some aspects, the assistance information comprises at least one of a scaling factor or an offset to be applied to adjust the measured metrics for the candidate cells; and the cell measurement report is for a subset of the candidate cells selected based on the adjusted measured metrics.

In some aspects, the assistance information comprises scaling factors or offsets that are applicable per candidate cell or per measured frequency.

In some aspects, the assistance information comprises a same scaling factor or offset to be applied to the measured metrics for multiple candidate cells on a particular frequency.

In some aspects, the method 1300 further includes transmitting signaling updating at least some of the assistance information, wherein the signaling comprises at least one of downlink control information (DCI), medium access control (MAC) control element (CE), or broadcast signaling. In some cases, the operations of this step refer to, or may be performed by, circuitry for transmitting and/or code for transmitting as described with reference to FIG. 14.

In some aspects, assistance information updated via the signaling comprises at least one of: at least one of a priority or scaling factor for candidate cells; cell loading for at least one of uplink or downlink; a cell configuration indicating at least one of frequency, time, or spatial resources; available resources per cell for a new UE; expected quality of service (QoS) for a new UE; or resources per cell for a new UE.

In some aspects, the signaling updates assistance information on at least one of a per-cell basis or a per-frequency basis.

In some aspects, the signaling comprises DCI or MAC CE signaling that activates or deactivates semi-persistent CSI reporting.

In one aspect, method 1300, or any aspect related to it, may be performed by an apparatus, such as communications device 1400 of FIG. 14, which includes various components operable, configured, or adapted to perform the method 1300. Communications device 1400 is described below in further detail.

Note that FIG. 13 is just one example of a method, and other methods including fewer, additional, or alternative steps are possible consistent with this disclosure.

### Example Communications Device(s)

FIG. 14 depicts aspects of an example communications device 1400. In some aspects, communications device 1400 is a user equipment, such as UE 104 described above with respect to FIGS. 1 and 3. In some aspects, communications device 1400 is a network entity, such as BS 102 of FIGS. 1 and 3, or a disaggregated base station as discussed with respect to FIG. 2.

The communications device 1400 includes a processing system 1405 coupled to the transceiver 1475 (e.g., a transmitter and/or a receiver). In some aspects (e.g., when communications device 1400 is a network entity), processing system 1405 may be coupled to a network interface 1485 that is configured to obtain and send signals for the communications device 1400 via communication link(s), such as a backhaul link, midhaul link, and/or fronthaul link as described herein, such as with respect to FIG. 2. The transceiver 1475 is configured to transmit and receive signals for the communications device 1400 via the antenna 1480, such as the various signals as described herein. The processing system 1405 may be configured to perform processing functions for the communications device 1400, including processing signals received and/or to be transmitted by the communications device 1400.

The processing system 1405 includes one or more processors 1410. In various aspects, the one or more processors 1410 may be representative of one or more of receive processor 358, transmit processor 364, TX MIMO processor 366, and/or controller/processor 380, as described with respect to FIG. 3. In various aspects, one or more processors 1410 may be representative of one or more of receive processor 338, transmit processor 320, TX MIMO processor 330, and/or controller/processor 340, as described with respect to FIG. 3. The one or more processors 1410 are coupled to a computer-readable medium/memory 1440 via a bus 1470. In certain aspects, the computer-readable medium/memory 1440 is configured to store instructions (e.g., computer-executable code) that when executed by the one or more processors 1410, cause the one or more processors 1410 to perform the method 1200 described with respect to FIG. 12, or any aspect related to it; and the method 1300 described with respect to FIG. 13, or any aspect related to it. Note that reference to a processor performing a function of communications device 1400 may include one or more processors 1410 performing that function of communications device 1400.

In the depicted example, computer-readable medium/memory 1440 stores code (e.g., executable instructions), such as code for obtaining 1445, code for measuring 1450, code for transmitting 1455, code for implicitly determining 1460, and code for receiving 1465. Processing of the code for obtaining 1445, code for measuring 1450, code for transmitting 1455, code for implicitly determining 1460, and code for receiving 1465 may cause the communications device 1400 to perform the method 1200 described with respect to FIG. 12, or any aspect related to it; and the method 1300 described with respect to FIG. 13, or any aspect related to it.

The one or more processors 1410 include circuitry configured to implement (e.g., execute) the code stored in the computer-readable medium/memory 1440, including circuitry for obtaining 1415, circuitry for measuring 1420, circuitry for transmitting 1425, circuitry for implicitly determining 1430, and circuitry for receiving 1435. Processing with circuitry for obtaining 1415, circuitry for measuring 1420, circuitry for transmitting 1425, circuitry for implicitly determining 1430, and circuitry for receiving 1435 may cause the communications device 1400 to perform the method 1200 described with respect to FIG. 12, or any aspect related to it; and the method 1300 described with respect to FIG. 13, or any aspect related to it.

Various components of the communications device 1400 may provide means for performing the method 1200 described with respect to FIG. 12, or any aspect related to it; and the method 1300 described with respect to FIG. 13, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1475 and the antenna 1480 of the communications device 1400 in FIG. 14. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1475 and the antenna 1480 of the communications device 1400 in FIG. 14.

### Example Clauses

Implementation examples are described in the following numbered clauses:
Clause 1: A method for wireless communications at a user equipment (UE), comprising: obtaining assistance information for prioritizing which candidate cells, from a configured set of candidate cells, are included in a cell measurement report, wherein the UE supports triggered mobility to switch between the candidate cells; measuring reference signals (RSs), wherein each of the RSs is associated with one of the candidate cells; and transmitting, based on the measuring, the cell measurement report that indicates at least one measured metric for different candidate cells that are selected in accordance with the assistance information.
Clause 2: The method of Clause 1, wherein the assistance information comprises priority information that is applicable per candidate cell or per measured frequency.
Clause 3: The method of any one of Clauses 1-2, wherein the assistance information indicates priorities for candidate cells and comprises at least one of: a first quality threshold that measured metrics for candidate cells should meet to be included in the cell measurement report; or a second threshold that measured metrics for candidate cells should meet to be included in the cell measurement report.
Clause 4: The method of Clause 3, wherein the measuring comprises: measuring RS for a first set of candidate cells with higher priorities than a second set of candidate cells; determining that a quantity of candidate cells whose measured metrics exceed the first quality threshold is less than a total quantity of cells to be reported; and measuring metrics for candidate cells in the second set based on the determination.
Clause 5: The method of any one of Clauses 1-4, further comprising implicitly determining a priority for a candidate cell based on at least one of: an identifier (ID) or order index of a radio resource control (RRC) message.
Clause 6: The method of Clause 5, wherein the RRC message configures the UE for measuring and reporting measuring results.
Clause 7: The method of Clause 5, wherein, if multiple cells are associated with a same ID, the priority for the multiple cells is determined based on the order index.
Clause 8: The method of any one of Clauses 1-7, wherein: the assistance information comprises at least one of a scaling factor or an offset to be applied to adjust the measured metrics for the candidate cells; and the cell measurement report is for a subset of the candidate cells selected based on the adjusted measured metrics.
Clause 9: The method of Clause 8, wherein the assistance information comprises scaling factors or offsets that are applicable per candidate cell or per measured frequency.
Clause 10: The method of Clause 8, wherein the assistance information comprises a same scaling factor or offset to be applied to the measured metrics for multiple candidate cells on a particular frequency.
Clause 11: The method of any one of Clauses 1-10, further comprising: receiving signaling updating at least some of the assistance information, wherein the signaling comprises at least one of downlink control information (DCI), medium access control (MAC) control element (CE), or broadcast signaling.
Clause 12: The method of Clause 11, wherein assistance information updated via the signaling comprises at least one of: at least one of a priority or scaling factor for candidate cells; cell loading for at least one of uplink or downlink; a cell configuration indicating at least one of frequency, time, or spatial resources; available resources per cell for a new UE; expected quality of service (QoS) for a new UE; or resources per cell for a new UE.
Clause 13: The method of Clause 11, wherein the signaling updates assistance information on at least one of a per-cell basis or a per-frequency basis.
Clause 14: The method of Clause 11, wherein the signaling comprises DCI or MAC CE signaling that activates or deactivates semi-persistent CSI reporting.
Clause 15: A method for wireless communications at a network entity, comprising: transmitting assistance information for prioritizing which candidate cells, from a configured set of candidate cells, are included in a cell measurement report; and receiving, based on measurement of reference signals (RSs) associated with the candidate cells, the cell measurement report that indicates at least one measured metric for different candidate cells that are selected in accordance the assistance information.
Clause 16: The method of Clause 15, wherein the assistance information comprises priority information that is applicable per candidate cell or per measured frequency.
Clause 17: The method of any one of Clauses 15-16, wherein the assistance information indicates priorities for candidate cells and comprises at least one of: a first quality threshold that measured metrics for candidate cells should meet to be included in the cell measurement report; or a second threshold that measured metrics for candidate cells should meet to be included in the cell measurement report.
Clause 18: The method of any one of Clauses 15-17, wherein: the assistance information comprises at least one of a scaling factor or an offset to be applied to adjust the measured metrics for the candidate cells; and the cell measurement report is for a subset of the candidate cells selected based on the adjusted measured metrics.
Clause 19: The method of Clause 18, wherein the assistance information comprises scaling factors or offsets that are applicable per candidate cell or per measured frequency.
Clause 20: The method of Clause 18, wherein the assistance information comprises a same scaling factor or offset to be applied to the measured metrics for multiple candidate cells on a particular frequency.
Clause 21: The method of any one of Clauses 15-20, further comprising: transmitting signaling updating at least some of the assistance information, wherein the signaling comprises at least one of downlink control information (DCI), medium access control (MAC) control element (CE), or broadcast signaling.
Clause 22: The method of Clause 21, wherein assistance information updated via the signaling comprises at least one of: at least one of a priority or scaling factor for candidate cells; cell loading for at least one of uplink or downlink; a cell configuration indicating at least one of frequency, time, or spatial resources; available resources per cell for a new UE; expected quality of service (QoS) for a new UE; or resources per cell for a new UE.
Clause 23: The method of Clause 21, wherein the signaling updates assistance information on at least one of a per-cell basis or a per-frequency basis.
Clause 24: The method of Clause 21, wherein the signaling comprises DCI or MAC CE signaling that activates or deactivates semi-persistent CSI reporting.
Clause 25: An apparatus, comprising: at least one memory comprising executable instructions; and at least one processor configured to execute the executable instructions and cause the apparatus to perform a method in accordance with any combination of Clauses 1-24.
Clause 26: An apparatus, comprising means for performing a method in accordance with any combination of Clauses 1-24.
Clause 27: A non-transitory computer-readable medium comprising executable instructions that, when executed by at least one processor of an apparatus, cause the apparatus to perform a method in accordance with any combination of Clauses 1-24.
Clause 28: A computer program product embodied on a computer-readable storage medium comprising code for performing a method in accordance with any combination of Clauses 1-24.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a graphics processing unit (GPU), a neural processing unit (NPU), a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by a user equipment (UE) may also (or instead) be performed by a network entity (e.g., a base station or unit of a disaggregated base station). Similarly, operations performed by a network entity may also (or instead) be performed by a UE.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

Means for obtaining, means for measuring, means for generating, means for transmitting, means for implicitly determining, and means for receiving may comprise one or more processors, such as one or more of the processors described above with reference to FIG. 14.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communications at a user equipment (UE), comprising:
at least one memory comprising computer-executable instructions; and
one or more processors configured to execute the computer-executable instructions and cause the apparatus to:
obtain assistance information for prioritizing which candidate cells, from a configured set of candidate cells, are included in a cell measurement report, wherein the UE supports triggered mobility to switch between the candidate cells;
measure reference signals (RSs), wherein each of the RSs is associated with one of the candidate cells; and
transmit, based on the measuring, the cell measurement report that indicates at least one measured metric for different candidate cells that are selected in accordance with the assistance information.

2. The apparatus of claim 1, wherein the assistance information comprises priority information that is applicable per candidate cell or per measured frequency.

3. The apparatus of claim 1, wherein the assistance information indicates priorities for candidate cells and comprises at least one of:
a first quality threshold that measured metrics for candidate cells should meet to be included in the cell measurement report; or
a second threshold that measured metrics for candidate cells should meet to be included in the cell measurement report.

4. The apparatus of claim 3, wherein the measuring comprises:
measuring RS for a first set of candidate cells with higher priorities than a second set of candidate cells;
determining that a quantity of candidate cells whose measured metrics exceed the first quality threshold is less than a total quantity of cells to be reported; and
measuring metrics for candidate cells in the second set based on the determination.

5. The apparatus of claim 1, wherein the one or more processors are further configured to cause the apparatus to implicitly determine a priority for a candidate cell based on at least one of: an identifier (ID) or order index of a radio resource control (RRC) message.

6. The apparatus of claim 5, wherein the RRC message configures the UE for measuring and reporting measuring results.

7. The apparatus of claim 5, wherein, if multiple cells are associated with a same ID, the priority for the multiple cells is determined based on the order index.

8. The apparatus of claim 1, wherein:
the assistance information comprises at least one of a scaling factor or an offset to be applied to adjust the measured metrics for the candidate cells; and
the cell measurement report is for a subset of the candidate cells selected based on the adjusted measured metrics.

9. The apparatus of claim 8, wherein the assistance information comprises scaling factors or offsets that are applicable per candidate cell or per measured frequency.

10. The apparatus of claim 8, wherein the assistance information comprises a same scaling factor or offset to be applied to the measured metrics for multiple candidate cells on a particular frequency.

11. The apparatus of claim 1, wherein the one or more processors are further configured to cause the apparatus to:
receive signaling updating at least some of the assistance information, wherein the signaling comprises at least one of downlink control information (DCI), medium access control (MAC) control element (CE), or broadcast signaling.

12. The apparatus of claim 11, wherein assistance information updated via the signaling comprises at least one of:
at least one of a priority or scaling factor for candidate cells;
cell loading for at least one of uplink or downlink;
a cell configuration indicating at least one of frequency, time, or spatial resources;
available resources per cell for a new UE;
expected quality of service (QoS) for a new UE; or
resources per cell for a new UE.

13. The apparatus of claim 11, wherein the signaling updates assistance information on at least one of a per-cell basis or a per-frequency basis.

14. The apparatus of claim 11, wherein the signaling comprises DCI or MAC CE signaling that activates or deactivates semi-persistent CSI reporting.

15. An apparatus for wireless communications at a network entity, comprising:
at least one memory comprising computer-executable instructions; and
one or more processors configured to execute the computer-executable instructions and cause the apparatus to:
transmit assistance information for prioritizing which candidate cells, from a configured set of candidate cells, are included in a cell measurement report; and
receive, based on measurement of reference signals (RSs) associated with the candidate cells, the cell measurement report that indicates at least one measured metric for different candidate cells that are selected in accordance the assistance information.

16. The apparatus of claim 15, wherein the assistance information comprises priority information that is applicable per candidate cell or per measured frequency.

17. The apparatus of claim 15, wherein the assistance information indicates priorities for candidate cells and comprises at least one of:
a first quality threshold that measured metrics for candidate cells should meet to be included in the cell measurement report; or
a second threshold that measured metrics for candidate cells should meet to be included in the cell measurement report.

18. The apparatus of claim 15, wherein:
the assistance information comprises at least one of a scaling factor or an offset to be applied to adjust the measured metrics for the candidate cells; and
the cell measurement report is for a subset of the candidate cells selected based on the adjusted measured metrics.

19. The apparatus of claim 18, wherein the assistance information comprises scaling factors or offsets that are applicable per candidate cell or per measured frequency.

20. The apparatus of claim 18, wherein the assistance information comprises a same scaling factor or offset to be applied to the measured metrics for multiple candidate cells on a particular frequency.

21. The apparatus of claim 15, wherein the one or more processors are further configured to cause the apparatus to:
transmit signaling updating at least some of the assistance information, wherein the signaling comprises at least one of downlink control information (DCI), medium access control (MAC) control element (CE), or broadcast signaling.

22. The apparatus of claim 21, wherein assistance information updated via the signaling comprises at least one of:
at least one of a priority or scaling factor for candidate cells;
cell loading for at least one of uplink or downlink;
a cell configuration indicating at least one of frequency, time, or spatial resources;
available resources per cell for a new UE;
expected quality of service (QoS) for a new UE; or
resources per cell for a new UE.

23. The apparatus of claim 21, wherein the signaling updates assistance information on at least one of a per-cell basis or a per-frequency basis.

24. The apparatus of claim 21, wherein the signaling comprises DCI or MAC CE signaling that activates or deactivates semi-persistent CSI reporting.

25. A method for wireless communications at a user equipment (UE), comprising:
obtaining assistance information for prioritizing which candidate cells, from a configured set of candidate cells, are included in a cell measurement report, wherein the UE supports triggered mobility to switch between the candidate cells;
measuring reference signals (RSs), wherein each of the RSs is associated with one of the candidate cells; and
transmitting, based on the measuring, the cell measurement report that indicates at least one measured metric for different candidate cells that are selected in accordance with the assistance information.

26. The method of claim 25, wherein the assistance information comprises priority information that is applicable per candidate cell or per measured frequency.

27. The method of claim 25, wherein the assistance information indicates priorities for candidate cells and comprises at least one of:
a first quality threshold that measured metrics for candidate cells should meet to be included in the cell measurement report; or
a second threshold that measured metrics for candidate cells should meet to be included in the cell measurement report.

28. A method for wireless communications at a network entity, comprising:
transmitting assistance information for prioritizing which candidate cells, from a configured set of candidate cells, are included in a cell measurement report; and
receiving, based on measurement of reference signals (RSs) associated with the candidate cells, the cell measurement report that indicates at least one measured metric for different candidate cells that are selected in accordance the assistance information.

29. The method of claim 28, wherein the assistance information comprises priority information that is applicable per candidate cell or per measured frequency.

30. The method of claim 28, wherein the assistance information indicates priorities for candidate cells and comprises at least one of:
a first quality threshold that measured metrics for candidate cells should meet to be included in the cell measurement report; or
a second threshold that measured metrics for candidate cells should meet to be included in the cell measurement report.
